(19) United States
(12) Patent Application Publication
(10) Pub. No.: US 2013/0151300 A1
(43) Pub. Date: Jun. 13, 2013

(54) Time Based Data Visualization

(71) Applicants: Vincent Le Chevalier, San Jose, CA (US); Charles F. Geiger, San Jose, CA (US); Brent S. Tworetzky, Palo Alto, CA (US); Ashit Joshi, San Jose, CA (US); Dax Eckenberg, Los Gatos, CA (US); Rahul Ravindra Mutalik Desai, San Jose, CA (US)

(72) Inventors: Vincent Le Chevalier, San Jose, CA (US); Charles F. Geiger, San Jose, CA (US); Brent S. Tworetzky, Palo Alto, CA (US); Ashit Joshi, San Jose, CA (US); Dax Eckenberg, Los Gatos, CA (US); Rahul Ravindra Mutalik Desai, San Jose, CA (US)

(73) Assignee: Chegg, Inc., Santa Clara, CA (US)

(21) Appl. No.: 13/706,343

(22) Filed: Dec. 5, 2012

Related U.S. Application Data
(60) Provisional application No. 61/741,772, filed on Dec. 9, 2011.

(51) Int. Cl. G06Q 50/20

(52) U.S. Cl. CPC G06Q 50/20; G06Q 10/063114
USPC 705/7.15

(57) ABSTRACT

An education digital reading platform collects time based user activity data and time based instruction data to generate time based views displaying a user's progress. User activity data includes any activity performed by a user on a web application displaying content from the education digital reading platform such as reading, taking notes, or answering questions. Time based instruction data includes a syllabus, due dates, and deadlines associated with a user's class. An interface system aggregates the user activity data from one or more users along with the instruction data to generate views of a user's progress. The views may be displayed, for example, as a timeline or a calendar. The views may enable a comparison between the activities of multiple users or a comparison of one or more user's activities to a syllabus.

### CROSS REFERENCE TO RELATED APPLICATIONS

This application claims the benefit of U.S. Provisional Application No. 61/741,772, filed Dec. 9, 2011, which is incorporated by reference in its entirety.

This application is related to U.S. Provisional Application No. 61/741,771, which is incorporated by reference in its entirety.

### BACKGROUND

1. Field of the Invention

This invention relates to a publishing platform for aggregating, managing, and delivering electronic content to connected consumer electronic devices.

2. Description of the Related Art

The education publishing industry faces a number of significant challenges to effectively delivering media and services through an on-line delivery network. These challenges center around four discrete phases:
1. Ingestion: A lack of digital textbook standardization, a plethora of incompatible formats, and a lack of integration and interoperability between publishers makes it difficult to ingest and aggregate a large volume of educational content efficiently and reliably.
2. Publishing: Significant transformation of education content needs to be undertaken to ensure that the content is suited to publish across a variety of client devices that users may use to access the content.
3. Distribution: In an electronic distribution environment, particular attention needs to be given to issues of content protection and rights management, as well as service policies and quality of service, so that content providers are fairly compensated and users of the content perceive the value and reliability of the service.
4. Connected Services: In an educational platform, there exists the potential to deliver a rich user experience that extends beyond electronic access to textbooks. To implement such connected services would require complex business rules and content models that are unavailable in existing education digital publishing services.

Effectively enabling and managing each of the above four phases has not yet been accomplished by the education publishing industry. Accordingly, this has inhibited the growth of delivering media and services through an on-line delivery network.

### SUMMARY

Embodiments of the invention provide an education digital reading platform that provides aggregation, management, and distribution of digital education content and services. An education digital publishing platform ingests content from a variety of content sources, transforms the content for web-based publication, distributes the content to connected end-user devices, and displays content to a user to deliver a rich user experience wherein the user can interact with the distributed content in ways that are unavailable in a traditional educational platform.

In one embodiment, the education digital reading platform includes an ingestion system. The ingestion system checks content files from a variety of content sources for conformity to one of a variety of content format standards, assigns a unique identifier to each content file, and stores the content files for access by other systems of the education digital reading platform.

In one embodiment, the education digital reading platform includes a publishing system. The publishing system deconstructs content, for example from PDF or ePUB format, to markup language pages such as HTML5 web format for distribution across a variety of consumer electronic devices connected to the platform via a network. The transformed content preserves the original page structure of the content document regardless of the original format of the content file. In one implementation, a correlation sub-system compares the rendered HTML5 pages to the original source pages, and establishes a correlation factor between the files that is indicative of the page fidelity quality. In one implementation, the publishing system also associates, creates, or extracts metadata for every content file added to the platform. For example, an enhanced metadata process creates an additional layer of metadata based on a combination of semantic analysis and business intelligence. The enhanced metadata can be used to support the delivery of services related to the education digital reading platform.

In one embodiment, the education digital reading platform includes a distribution system. The distribution system packages the content for delivery, uploads the content to content distribution networks, and makes the content available to end-users based on the digital rights management policies that govern access to that content. The users access the content and related services from client devices connected via a network. For example, client software within a HTML5 compatible browser on the user's client device receives HTML5 formatted content along with a host of document specific metadata that enhance the user's reading experience with the document.

In one embodiment, the education digital reading platform leverages an education lifecycle by accumulating detailed information about activities. An education lifecycle for a class may include due dates and deadlines associated with assignments, exams or an instructor's office hours from the beginning to the end of an educational course. Such information, for example may be provided by a syllabus. In one embodiment, the education digital reading platform identifies dates and times associated with one or more educational activities to provide a visualization interface. In addition, the education digital reading platform records user activity data associated with viewing content published on the digital reading platform. A visualization interface of the education digital reading platform may use the accumulated user activity data and education lifecycle data to generate time based activity views. The time based user activity views may be generated for a user, or for a group of users associated with the user, associated with an instructor, or associated with a publisher or author of the content within the education digital reading platform. As such, the time based user activity views may help a viewer track historical activity and may help guide future activity within the education digital reading platform.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 is a high-level block diagram of a platform environment in accordance with an embodiment of the invention.

FIG. 2 illustrates a block diagram of an ingestion system, in accordance with an embodiment of the invention.

FIG. 3 illustrates a block diagram of a publishing system, in accordance with an embodiment of the invention.

FIG. 4 illustrates a block diagram of a distribution system, in accordance with an embodiment.

FIG. 5 illustrates a block diagram of a back-office system, in accordance with an embodiment.

FIG. 6 illustrates a block diagram of an eCommerce system, in accordance with an embodiment.

FIG. 7 illustrates a process for providing a time based user activity view, in accordance with an embodiment.

FIG. 8 illustrates a predictive time based user activity view, in accordance with an embodiment.

FIG. 9 illustrates a time based user activity view, in accordance with an embodiment.

FIG. 10 illustrates an aggregate time based user activity view, in accordance with an embodiment.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

### System Overview

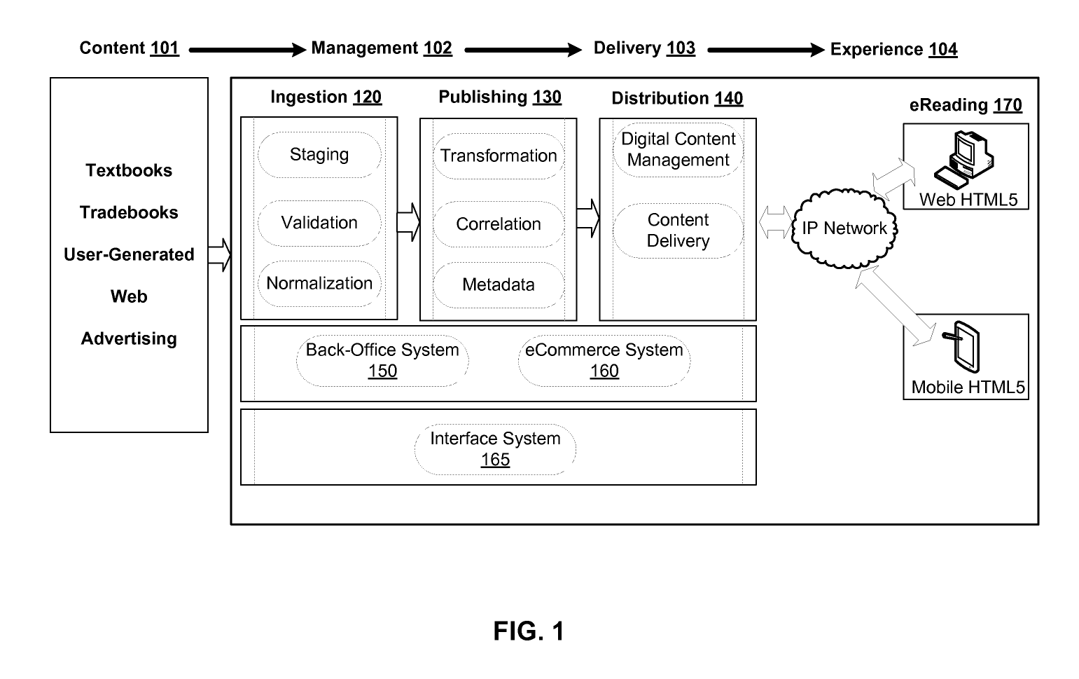

Embodiments of the invention provide an education digital reading platform that provides aggregation, management, and distribution of digital education content and services. The platform is an integrated solution for delivering content and education services through an on-line delivery network to connected client devices. FIG. 1 is a high-level block diagram of the platform environment in accordance with an embodiment of the invention. As illustrated in FIG. 1, the platform is organized around four main function blocks: content 101, management 102, delivery 103, and experience 104.

Content 101: The platform is configured to automatically gather and aggregate content from a large number of sources, categories, and partners. Examples of content include textbooks, tradebooks, user-generated content, web content, and advertising content. The content function block 101 of the platform collects the content into a formalized staging environment for further processing by the platform.

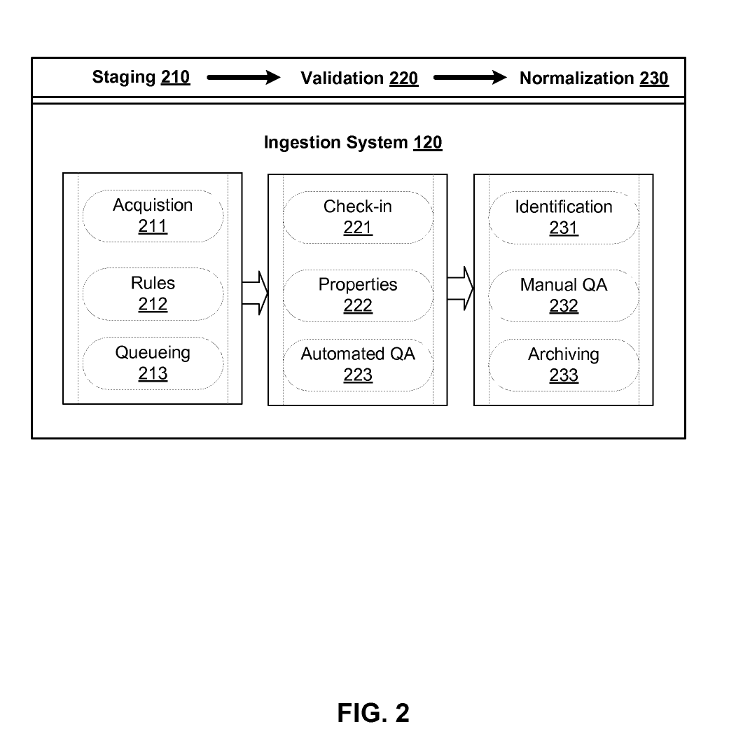

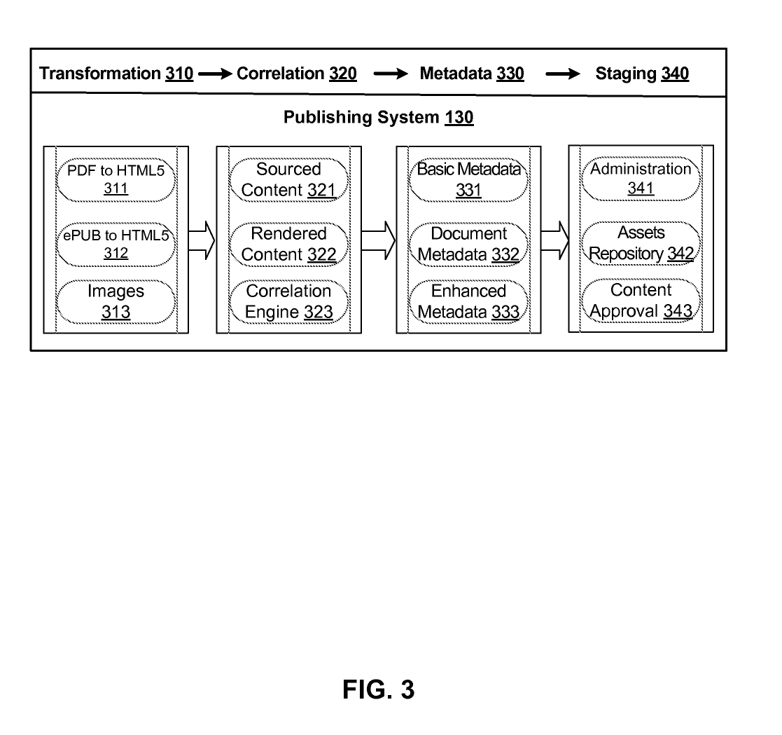

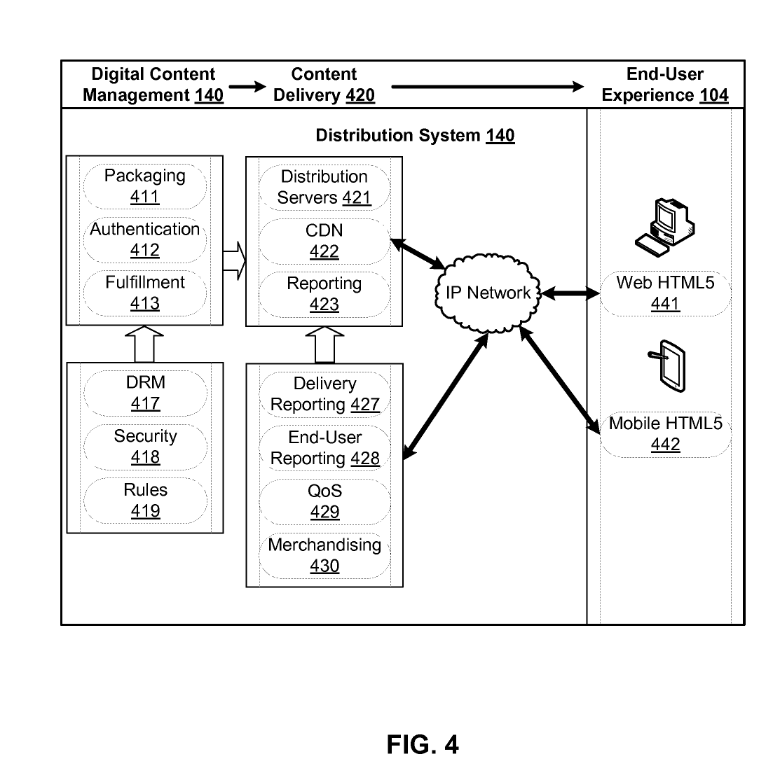

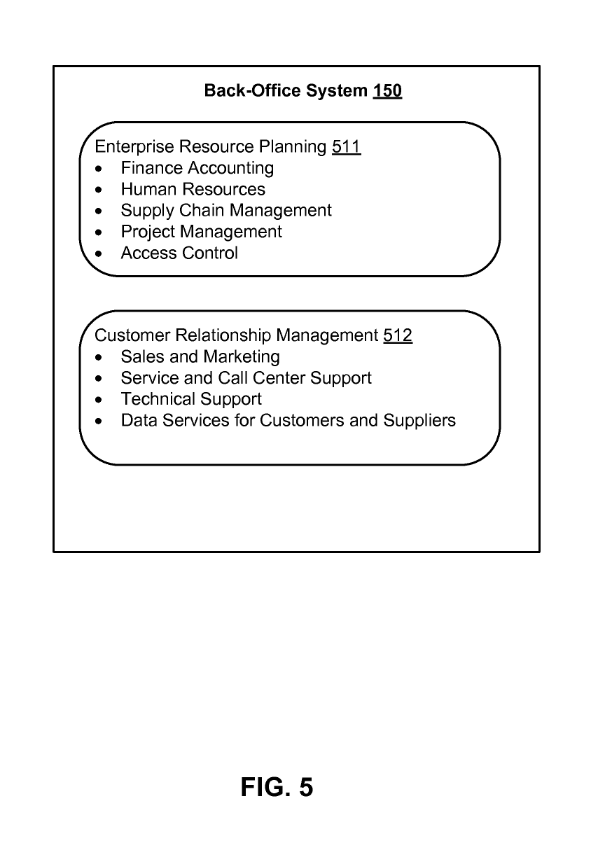

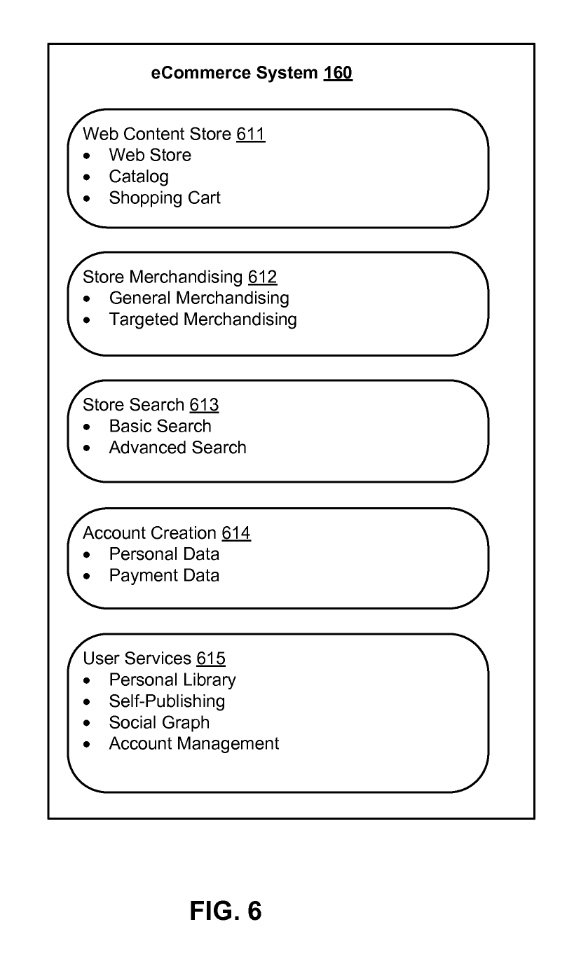

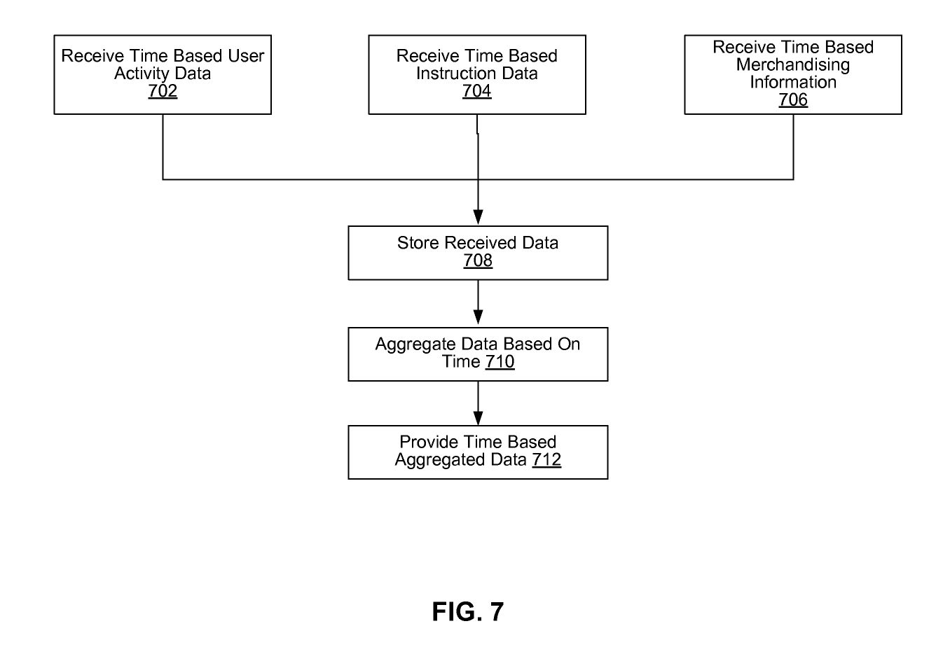

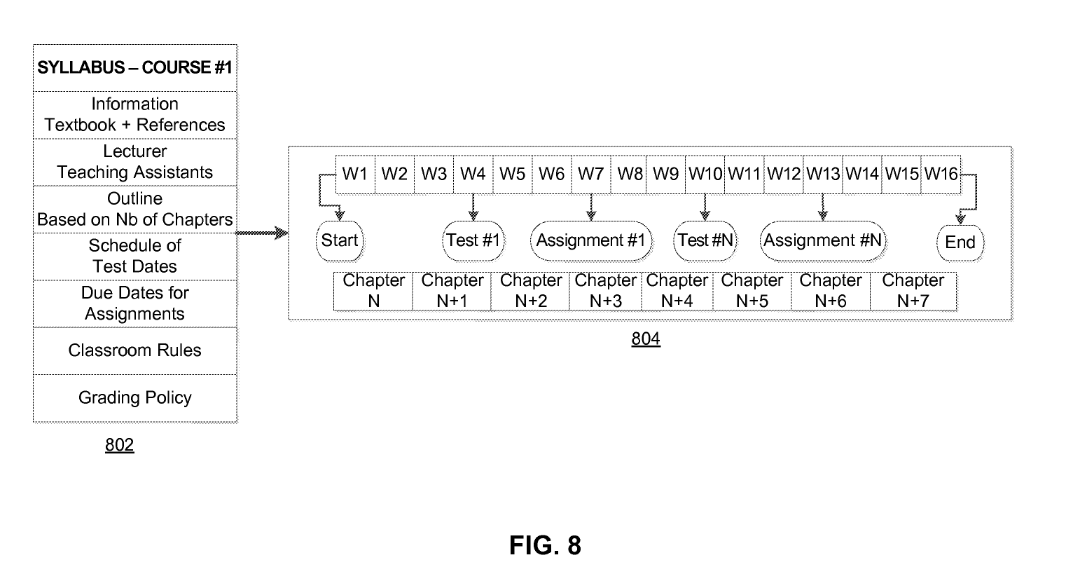

Management 102: The management function block 102 represents the core of the platform. The management function block 102 is based on six sub-systems and related processes, including ingestion 120, publishing 130, distribution 140, back-office 150, eCommerce 160, and interface 165. The management function block 102 aggregates, validates, transforms, packages, and monetizes the content collected by the content function block 101 into a number of business services, prior to distribution by the platform. The ingestion sub-system 120 will be described in detail with reference to FIG. 2, the publishing sub-system 130 with reference to FIG. 3, the distribution sub-system 140 with reference to FIG. 4, the back-office sub-system 150 with reference to FIG. 5, the eCommerce sub-system 160 with reference to FIG. 6, and the interface sub-system 165 with reference to FIGS. 7 and 8.

Delivery 103: In the delivery function block 103, wired and wireless delivery networks are used to distribute content and services seamlessly across a wide variety of connected consumer devices. The delivery function block 103 packages the content for end-user consumption by distributing it across a hybrid network of traditional Content Delivery Networks (CDN) and other infrastructure. Content is then authorized for on-line delivery based on end-user rights management, content policies and user profiles. The delivery function block 103 also monitors and reports overall quality of service, and network and distribution specific activities, in some embodiments.

Experience 104: In the experience function block 104, users access the content from web browsers on consumer devices connected to a network, such as a personal computer (such as a desktop, laptop, or tablet computer), a personal digital assistant, a mobile or smart phone, or a television “set-top box” using a client web application. As a result of transforming education content and serving it through this platform, users enjoy high-quality and consistent education reading experiences and connected services. As the user experiences the content, the user's web browser regularly communicates with the platform for updating reading content and connected services. This client-server communication system is used to aggregate and upload various end-user data to report the user's reading activities to the platform as well as checking the type and quality of the network to which the user's device is connected.

In one implementation, contrary to other existing digital publishing services such as Amazon Kindle, the user is not required to download a specific reading application from the publisher on to an end-user device in order to access the content. There is no stand-alone application needed to access the education content and services. Rather, client software within a HTML5 compatible browser on the user's computer receives structureless HTML5 page elements to reconstruct pages of a document, along with a host of document specific metadata that enhance the user's reading experience with the document, such as, for example, thumbnail navigation and an interactive table of contents. The client software integrates a number of the user's reading activities, such as, for example, creating highlights, taking notes, and accessing a dictionary. Annotation services enable a reader to create highlights, drawings, notes, comments, and other personalized data that is overlaid within the original content. This type of user-generated content is stored and archived into the on-line end user account so that it can be synchronized across all registered devices for given end-user. Thus, the user's user-generated content can be accessed from any of the user's registered devices. Moreover, the platform enables the user-generated content and other user activities to be optionally shared among friends, classmates, campus, or other groups, as part of an education social platform.

### Ingestion System

FIG. 2 illustrates a block diagram of an ingestion system 120, in accordance with an embodiment of the invention. The ingestion system 120 is a sub-system of the management function block 102 of the platform illustrated in FIG. 1. The ingestion system 120 includes three primary sub-systems: staging 210, validation 220, and normalization 230.

Staging 210: The content staging sub-system 210 of the ingestion system 120 includes three processes: acquisition 211, rules creation 221, and queueing 213. The acquisition process 211 includes mapping the source and characteristics of all the content to be ingested. Example characteristics include type of content (such as user-generated content), file formats (such as PDF/A, ePub, etc.), and file manifest (a list of files associated to a specific title). Depending on the type of content, this process includes receiving inputs from various parts of the platform. The rules creation process 212 includes creating individual rules to determine ownership, file location, characteristics, properties, naming conventions, and other operational data that govern content for any given source, based on the acquisition process. Then, based on the rule definition, the content is queued 213 for subsequent processing.

Validation 220: The validation sub-system 220 of the ingestion system 120 includes three processes: check-in 221, properties 222, and automated quality assurance 223. The check-in process 221 checks file integrity and conformity to standards, for example PDF, ePUB2, ePUB3, XML, HTML, and other content formats. The properties process 222 associates content files that pass the check-in process 221 to a manifest that records changes applied to the content in subsequent processing of the content for publication by the platform. Content files that do not pass the check-in process 221 are flagged for further testing and validation. The further testing and validation may be performed, for example, by an automated quality assurance process 223. The automated quality assurance process 223 can support a large amount of content processed within the ingestion system 120.

Normalization 230: The normalization sub-system 230 of the ingestion system 120 includes three processes: identification 231, manual quality assurance 232, and archiving 233. The identification process 231 assigns a unique identifier to each processed content file that identifies the content within the platform. The manifest for each content file is updated to include basic properties such as file name, size, source, type, time, and other ingestion specific processed data. In the manual quality assurance process 232, files that were flagged by the automated quality assurance process 223 of the validation sub-system 220 may be further inspected by a team of quality assurance engineers. Files that cannot be repaired are returned to their owner for correction. In the archiving process 233 of the normalization subsystem 230, files that are successfully processed and identified are stored in a database for access by the publishing system 130.

### Publishing System

FIG. 3 illustrates a block diagram of a publishing system 130, in accordance with an embodiment of the invention. The publishing system 130 is a sub-system of the management function block 102 of the platform illustrated in FIG. 1. The publishing system 130 transforms ingested printed and other documents into, for example, an HTML5 web format (or other markup language with suitable characteristics) with enhanced metadata, which is well-suited to distribution across a wide variety of consumer electronic devices connected to the platform via a network. It is noted that although embodiments of the invention are described herein with reference to HTML5, other markup languages with suitable characteristics may also be used in place of HTML5. The transformed content preserves the original page structure of the printed document, including the pagination of the original printed document, the number of columns and arrangement of paragraphs, the placement and appearance of graphics, titles and captions, and the fonts used, which are collectively referred to as preserving “page fidelity” of the printed document. Page fidelity is preserved by the publishing system 130, regardless of the original format of the source content provided by the content provider, and regardless of the complexity of the layout of the original document. The publishing system 130 includes four primary sub-systems: transformation 310, correlation 320, metadata 330, and staging 340.

Transformation 310: The transformation sub-system 310 of the publishing system 130 includes three processes: PDF to HTML5 311, ePUB to HTML5 312, and images 313. In the PDF to HTML5 process 311, normalized PDF files are converted into sets of HTML5 web pages. This process keeps the page structure of the original file so that page fidelity is maintained even after the transformation to HTML5 is completed. In the ePUB to HTML5 process 312, similarly to PDF files, normalized ePUB files are converted into sets of HTML5 pages. This approach removes the need to download ePUB files or PDF files along with a specific ePUB reader or PDF reader application to end-user devices. Thus, all published content is transformed into a set of secured downloadable individual HTML5 pages regardless of the original source content format. In the images process 313, all image content is transformed into bit maps. These bit maps can be exact copy images of the original source content before the transformation process is applied.

Correlation 320: The correlation sub-system 320 of the publishing system 130 includes three processes: sourced content 321, rendered content 322, and correlation engine 323. During the HTML5 transformation, the page fidelity quality of the original document can be compromised by special characters, unusually complex layout and target Web Browser HTML conformity issues. To identify these potential differences, the correlation sub-system 320 compares the rendered HTML5 pages to the original source pages, and establishes a correlation factor between these files. The sourced content process 321 analyzes the original sourced content. Similarly, the rendered content process 322 analyzes the HTML5 rendered content. The correlation engine process 323 establishes a correlation factor between the sourced content and the rendered content that is indicative of the page fidelity quality. The correlation engine process 323 may use multiple different analysis techniques for comparing the sourced content and the rendered content, and the selection of a particular technique for a page may depend on the complexity of the page. For a simple page of only text, a simple text recognition algorithm may be used. For a complex document including various graphics, a mathematical process of analysis and comparison similar to a video face recognition algorithm that has been applied to complex document layout recognition can be used. In one embodiment, the correlation engine process 323 is configured to automatically analyze and compare large volumes of rendered HTML5 content across a matrix of targeted web browsers, such as Internet Explorer, Safari, Firefox, Opera, and other browser implementations, without manual intervention. For example, a typical book of several hundred pages, once converted into a single set of HTML5 pages, is tested against a matrix of selected web browsers for page fidelity accuracy. This involves potentially thousands of HTML5 pages that an automated system needs to analyze and flag for potential page fidelity problems. If the correlation factor does not at least meet a minimum threshold established for page fidelity quality, the page is flagged.

Metadata 330: The metadata sub-system 330 of the publishing system 130 includes three processes: basic metadata 331, document metadata 332, and enhanced metadata 333. These metadata processes together form the basis for services that augment the user experience.

In the basic metadata process 331, a set of basic metadata is associated to every file added to the platform. Content sources in PDF and ePUB formats may be identified by their unique ISBN number. Once validated, ISBN numbers are matched against metadata sources such as the “ONIX for Books” international standard that describes a comprehensive list of data elements and components. Typically, basic metadata represents a small subset of the ONIX standard, including author, title, publisher name, release date, short description, cover page, and other book specific data that are selected by the service provider amount a pre-determined set of available data. As not all content can be associated with an existing ISBN number, for example user-generated content or unpublished academic content, the basic metadata process 331 also automatically extracts metadata by the analysis of file properties and content indexing for key word detection.

The document metadata process 332 creates and extracts metadata by deconstructing documents into basic elements of information. A partial list of document specific metadata includes, for example, sizes of images, types of images (such as graphs, tables, and pictures), locations, captions, number and size of columns, paragraphs, type of layout, embedded references, partial and full content indexing, border size, blank pages, and many others. Collectively, these document specific metadata are referred to herein as “document structure metadata.” Document structure metadata identifies the location and composition of elements of information that make up a printed document. For example, the document structure metadata can identify the part of the document, such as title, subtitle, chapter, caption, image, sample questions, and the like, as well as where it is located within the printed document page.

The document metadata process 332 extracts metadata by deconstructing documents into basic elements of information by following a collection of rules to identify the parts of the document. For example, a page may be analyzed to determine the location of every character, blank space, and image on the page. The fonts of the characters are also analyzed to group characters into regions having the same font. To determine whether a region corresponds to a heading, subheading, body text, caption, or other identifiable part of the page, the relative size of the font, the position of the region relative to other known regions or objects, and the presence/absence of numbers that appear in a table of contents or index, may be considered. In one implementation, a series of rules are applied to categorize a region. For example, a region that has a larger font, has relatively few words, and spans more than one column is a heading. A region that is adjacent to an image and has relatively few words, is a caption. Reference to an index and/or table of contents of the document may also be helpful in classifying regions, as they may list the page numbers on which sections, images, etc., appear.

In one embodiment, by extracting document structure metadata during ingestion and storing it in connection with the ingested document, the platform has knowledge about the document that may be applied to delivering a richer reading experience to an end user. For example, if it is known that a particular segment of text is a caption for a picture on page of document, the picture and caption can be replaced or alternately shown with a multimedia element, for example a slide show with appropriate captions, a video clip with a related caption, or the like. As another example, if it is known that a section of a chapter of a text book contains review questions, the section can be replaced with an interactive quiz covering related content. As still other examples, substitutions or additions to other parts of a document may include merchandising offers, links to related content, or feedback mechanisms to teachers and/or authors.

The enhanced metadata process 333 relies on the outcome of both the basic metadata process 331 and the document metadata process 332 to create an additional layer of metadata based on the combination of semantic analysis and business intelligence, in one implementation. From the fully indexed content, a semantic analyzer identifies key concepts, words and expressions that are necessary to support enhanced search features from within specific content as well as across one or more categories of content. From business intelligence, additional metadata such as content ratings, awards, bundles, discount prices, free chapters and reviews are among various other elements of information that may be included as enhanced metadata.

In one embodiment, content of any document may be extracted by the document metadata process 332 and the enhanced metadata process 333. For example, a document provided by an instructor, such as a syllabus, may be analyzed to identify regions associated with time or deadline to identify an item and its due date within a syllabus. In one embodiment, the syllabus information may be used to provide a timeline view to a user such that the user can track his or her activities and performance against those suggested or required by the syllabus. Generating a time based user interface is described in greater detail with reference to FIGS. 7 and 8.

Staging 340: The content staging sub-system 340 of the publishing system 130 includes three processes: administration 341, assets repository 342, and content approval 343. In the administration process 341, the content workflow is monitored, for example, by monitoring the recorded changes to the content in the file manifest to enable the identification and correction of any remaining quality issues, such as pages that have been flagged by previous processes for quality concerns. The assets repository process 342 stores the processed content, metadata, and other assets in preparation for final approval prior to delivery. The content approval process 343 validates content that meets the quality requirements and marks the content as approved for distribution. At this point, the content is prepared for final delivery to end-users.

### Distribution System

FIG. 4 illustrates a block diagram of a distribution system 140, in accordance with an embodiment. The distribution system 140 is a sub-system of the management function block 102 of the platform illustrated in FIG. 1. The distribution system 140 packages the content for delivery, uploads the content to content distribution networks, and makes the content available to end-users based on the content's digital rights management policies. Functionally, the distribution system 140 includes two primary sub-systems: digital content management 410 and content delivery 420.

Digital content management 410: The digital content management sub-system 410 includes three processes: packaging 411, authentication 412, and fulfillment 413.

The packaging process 411 packages together all files associated with a particular portion of a content file, referred to as an “asset,” before the asset is distributed. Specifically, content and metadata files include, for example, pictures of different resolution, character fonts, thumbnails, and a bookmarked table of contents, that are combined together into a data package that represents the asset.

The authentication process 412 prepares the content for distribution according to content protection mechanisms that may vary according to service offerings, may vary according to publishers, and/or even may vary according to individual assets. The authentication process 412 receives input from DRM module 417, security module 418, and rules module 419. The DRM module 417 encrypts content into a DRM layer, typically using Advanced Encryption Standard (AES) Kerberos 128, which protects the content from being easily copied by end-users once it is partially downloaded to their client device. The security module 418 protects content by additional security layers defined at the service level, in one embodiment. These additional security layers are typically the result of complex eCommerce business rules that specify how content needs to be protected. The rules module 419 defines the business rules governing content protection that are specific to content owners, may be specific to the particular service being deployed and/or the specific asset. The level of content protection can be adjusted based on the content that is being distributed across particular services. As an example, a publisher or a service provider may want to limit the number of pages that can be printed by the end-user. As another example, a chapter of a book may be available for free. As another example, content may be bundled into time-based promotional offers.

The fulfillment process 413 tracks the status of an order once a purchase order is received by the management function block 102 of the platform. The content associated with the order is identified, associated to the account that created the order, and marked for distribution. The fulfillment process 413 reports the status of the order to the eCommerce system 160 of the management function block 102. As an example, a typical order is processed through a number of logical steps, including order configuration, order booking, acknowledgement/confirmation, invoicing/billing, order changes, order processing, delivery, settlement, and returns/refunds.

Content delivery 420: The content delivery sub-system 420 handles the delivery of content to end-users. The content delivery sub-system 420 includes three processes: distribution servers 421, content distribution networks 422, and reporting 423.

The distribution servers process 421 centralizes the content available for distribution before uploading it to the content distribution networks (CDN), based on the outcome of the digital content management sub-system 410. User-generated content created by end-user web applications is also uploaded by the distribution servers process 421 so that it can be stored, synchronized and redistributed to the CDN network for later consumption.

The content distribution networks process 422 uploads content to the CDN origin server. Once the content is uploaded to the CND origin server, the content is pushed automatically to CDN edge servers geographically distributed around the country where each page and elements of a document are referenced with its own short time-based URL shared with an end-user web application. Hence, the content is effectively protected from unauthorized distribution. In one implementation, third-party CDN server infrastructure, such as Akamai for example, is used to host the content closer to end-users, facilitating scalability and performance requirements of the server infrastructure while improving user experience access time to the content.

The reporting process 423 receives input from a delivery reporting module 427, an end-user reporting module 428, and a quality of service module 429 in order to report on issues that may affect the user's experience or digital right management. The delivery reporting module 427 reports content that is recorded as delivered to the end-user web application so that content delivery issues can be monitored across the CDN and distribution servers. As examples, incorrect URLs or obsolete time sensitive URLs need to be identified and renewed based on the digital content management sub-system 410.

The end-user reporting module 428 receives reports from the end-user web application that monitors reading activities. In one embodiment, the end-user reporting module aggregates these into a report on a frequent periodic basis. Examples of activities tracked include the number of printed document pages and volume of copy/paste activities, as defined by business rules specified by individual publishers or platform-wide business rules. In one embodiment, the content published to the user may include learning activities such as questions, provided by an instructor or by other users of the system. In such an embodiment, the activities may include answering the questions or posting questions with the system. In one embodiment, the end-user reporting module 428 receives a time stamp associated with each activity performed by the user. For example, the end-user reporting module 428 may receive a start time when a user accessed a page to start reading and an end time wherein the user accessed another page indicating that the user stopped reading the first page. Similarly, the end-user reporting module may receive a start and end time stamp associated with any activity along any granularity of detail, including but not limited to time and duration of when a user viewed a page, a paragraph, an image, a video, answered a question, etc. The activity information received by the end-user reporting module 428 may be provided to the interface system 165 to generate time based views for a user, as described in greater detail in reference to FIGS. 1, 4, 7 and 8.

The quality of service module 429 aggregates data reported by web applications and their users to identify service level issues that are possibly affecting the overall quality of the user experience. Examples of quality of service issues include incorrectly formatted content, CDN latencies or content synchronization issues.

In one embodiment, a merchandising module 430 generates time based merchandising offers based on products offered by the education digital reading platform and content displayed to a user on a web application. For example, if the education digital reading platform is offering a discounted digital book on the U.S. Civil War and a user is viewing content on the U.S. Civil War, the merchandising module 430 may offer the discounted digital book to the user when the user is reading the published content or when the user is supposed to read the published content based on a class syllabus or schedule ingested by the education digital reading platform. Similarly, the merchandising module 430 may provide a merchandising offer for other products or services offered through the education digital reading platform or external to the education digital reading platform based on the user's activities as various times.

### Back-Office System

FIG. 5 illustrates a block diagram of a back-office system 150, in accordance with an embodiment. The back-office system 150 is a sub-system of the management function block 102 of the platform illustrated in FIG. 1. The back-office system 150 integrates the processes dedicated to running the business, identified as enterprise resource planning 511 and the processes dealing with the customers for the business, globally identified as customer relationship management 512.

Within enterprise resource planning 511, the back-office system 150 performs finance accounting tasks such as maintaining the general ledger, tracking payables and receivables, managing the cash and fixed assets, and budgeting. The back-office system 150 also handles human resource tasks such as payroll, training, benefits, recruiting, and diversity management, as well as handling supply chain management, including inventory, order entry, purchasing, claim processing, and commissions. The back-office system 150 may also be used for project management, including costing, billing, time and expense calculations, performance units, and activity management. Lastly, the enterprise resource planning 511 of the back-office system 150 may also be used to control access and manage user privileges for internal and external processes.

Within customer relationship management 512, the back-office system 150 manages the interactions with the customers, clients, and sales prospects by synchronizing business specific processes, including sales and marketing, customer service and call center support, technical support, and data services for customers and suppliers.

eCommerce System

FIG. 6 illustrates a block diagram of an eCommerce system 160, in accordance with an embodiment. The eCommerce system 160 is a sub-system of the management function block 102 of the platform illustrated in FIG. 1. The eCommerce system 160 manages the online processes of marketing, selling, servicing and receiving payment for digital products and services. As such, the eCommerce system 160 is closely interfaced to the publishing system 130 and distribution system 140, as well as to the back-office system 150. The eCommerce system 160 components include the web content store 611, store merchandising 612, store search 613, account creation 614, and user services 615.

The web content store component 611 presents to customers all available content and services. The web store is accessed by connecting to an on-line website that defines how content is being offered to customers. For example, a digital education store includes a large library of textbooks, academic content, and other tradebooks, such as Biology, Economics, and Philosophy, for example, as well as various education and social specific services that are offered to students, teachers, and other users. The web content store 611 also includes at least one product content catalog that assembles content available from the web store. Catalogs may be organized around content categories, topics, or types, and may include metadata such as pricing, professional reviews, awards, descriptions, user reviews and thumbnails, for example. The web content store 611 also includes a shopping cart. The shopping cart is a software component that allows web content store customers to accumulate a list of items for purchase. Upon checkout, the shopping cart software typically calculates a total for the order, including taxes, as applicable.

The store merchandizing component 612 comprises general merchandizing and targeted merchandising. General merchandising includes promoting specific products from the content catalog and offering them for sale at the web content store 611. This is a sales driven activity that is usually accomplished via a combination of analytics, product placement, price offerings, promotion and other business intelligence services. Targeted merchandising includes presenting specific products and services that are tailored to the end-user or group of end-users based on their respective profiles, analytics and/or reported activities.

The store search component 613 includes in one implementation a basic search and an advanced search. The basic search comprises searching through the available store content. Typical searches include document titles, topics, categories, authors, publishers and other available catalog metadata. The advanced search comprises searching for key words or specific expressions within the available content store. In this advanced search mode, the user provides the search engine with a phrase which defines a semantic concept for which the user is trying to gather information. The results of the search typically locate a number of documents that together aggregate the information desired to be gathered.

The account creation component 614 creates and registers a secure account for a user, so that the user is able to purchase content and services from the web content store 611. The account creation component 614 stores personal account data, such as name, address, email, phone number, login and password information. In addition to personal data, end users may also enter their payment information such as credit card number, PayPal or bank account details in order to be able to purchase content and services from the web content store 611. Payment data is then linked to the shopping cart for processing purchases as they occur.

The user services component 615 manages a number of customer-based services that are available as part of the web content store 611 offerings. For example, a digital education platform may include a number of services such as personal library, self-publishing, a user's social graph, and account management, among others.

The personal library is the aggregation of content and services purchased and created over time by an individual end user. In a digital education platform, it would typically include all textbooks and tradebooks purchased by a student, as well as all the student's user-generated content such as notes, highlights, and other comments.

Self-publishing is a service offered to end users interested in publishing their own content. In a digital education platform, a student or teacher may have content that they would want to share with their peers. For example, a student may have developed a course outline or other study materials to share with other students, and a teacher may have lecture materials or practice exams to share with other teachers or students. As such, the self-publishing service would ingest that content into the platform and add it to the content catalog, or a subset of it, as identified by the end user rights and privacy settings.

In one embodiment, the social graph is a system to determine, display, and act upon the relationships among all users of the online education platform, including students, teachers, and authors. For example, the social graph of a student is the collective connections between the student and the student's teachers, classes, classmates, etc. The social graph of a teacher is the collective connections between the teacher and the teacher's students, classes, colleagues, etc. The social graph of an author is the collective connections between the teachers that use the author's book, the students reading the author's book, etc. Collectively, these links and connections define how specific content and services can be tailored and proposed to specific end users.

Account management includes user-specific services that are dedicated to the setting, management, and monitoring of a particular account, including privacy, personal data, transaction listings, banking information and social graph information among other aspects.

### Time Based Data Visualization

Referring again to FIG. 1, the interface system 165 receives time based information and generates user interface elements to display a time based view to a user on a web application executing on a client device. The interface system 165 may generate one of many views for a user, including but not limited to an instructive view, a user activity view and an aggregate user activity view. An instructive view includes instruction information provided for the user's instruction. For example, instruction information includes dues dates and deadlines associated assignments, exams, etc. In one embodiment, the interface system 165 aggregates time based data received from the metadata processes 332 and 333, and end-user reporting module 428 to identify such due dates and deadlines. For example, such due dates may be obtained from a user's syllabus or other course instruction materials as well as a user's calendar. The instructive view is described in greater detail with reference to FIG. 8.

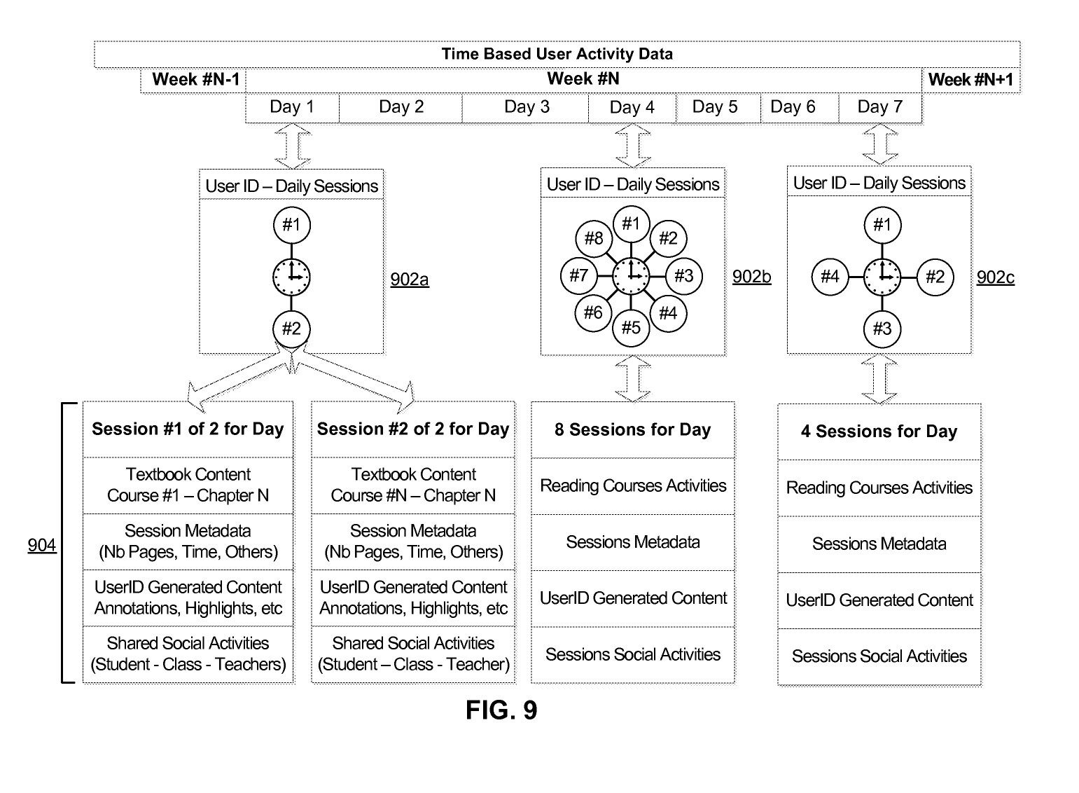

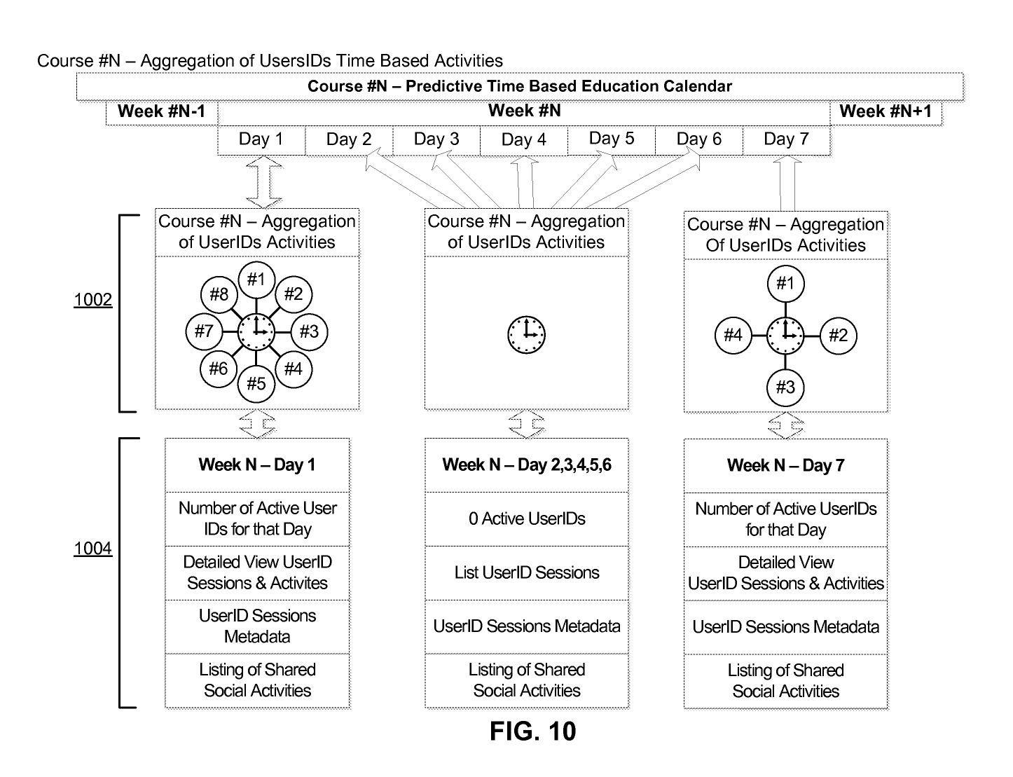

A user activity view provides dates and times associated with user activity on the education digital reading platform. For example, if a user reads a page of a book or completes an interactive quiz, the date and time as well as the user's performance may be provided to the user in the user activity view. The user activity view is described in greater detail in reference to FIG. 9. An aggregate user activity view includes dates and times of when other users associated with the users viewed or completed a user activity. The aggregate user activity view may allow a user to track his or her performance against other users/peers in a same classroom. Similarly, teachers may use the aggregated user view to track progress of students and/or to compare performance metrics against time based user activity data. The aggregate time based user activity interface is described in greater detail with reference to FIG. 10.

FIG. 7 illustrates a process for providing time based views to a user, in accordance with an embodiment. In one embodiment, the process receives 702 time based user activity data. User activity data may include, for example, viewing published content by accessing a page, or interacting with a learning activity with published content by answering questions, posting questions, highlighting content, inserting notes, flags or reminders, etc. Content published to the user may include text, images, graphs, tables, video etc., associated with a textbook or quizzes, exam notes, highlights and other content provided by users of an education digital reading platform. In one embodiment, the process receives 702 user activity data containing very granular detail about a user's activity within the education digital reading platform. As such, the user activity data may include granular details about when and how long a user viewed each individual page, paragraph, image or other item within the content.

In addition, the time based user activity data received 702 by the education digital reading platform may also include a start time and an end time associated with each interaction. Thus, a time and length of each activity may be determined by the education digital reading platform. In one embodiment, the time based data includes at least one of an activity month, week, day of the week, date and a time. When a student starts reading published content on a web application executing on a client device, the web application sends a read now request to the digital reading platform wherein the platform creates a session that starts capturing user activities within that session until such time when the user closes the published content on the client device. From a procurement of published content or a beginning of a semester to the end of the semester, there can be multiple sessions per day, over the course of several weeks or months, or until the end of the education lifecycle. In one embodiment, the process receives 702 time based activity data for each user associated with the education digital reading platform over the course of an education lifecycle.

In one embodiment, the process receives 704 time based instruction data from a source associated with each user. For example, time based instruction data may comprise a syllabus received from a user's instructor, a calendar or a task list associated with a user's group, or other information associated with a user such as a content expiration date, etc. In one embodiment, the process may ingest the received information, such as a syllabus or a task-list to identify time based instruction data. For example, the process may identify exam dates, project or homework due dates. Similarly, the process may ingest a user's calendar to identify vacation dates associated with the user.

Optionally, the process receives 706 time based merchandising information from an education digital reading platform. For example, the merchandising information may include discounts or advertisements for renting or purchasing supplementary content on the education digital reading platform or offers for tutoring services associated with a user's class, instructor, publisher, etc.

In one embodiment, the process stores 708 the received time based user activity data, the received time based instruction data, and optionally, the received time based merchandising information. The received information may be stored 708 on a computing device associated with the education digital reading platform such that it is available to one or more systems therein. Additionally, the received information can be associated with an individual user, group of users, or stored for general use within the education digital reading platform.

In one embodiment, the process aggregates 710 the received data based on time. For example, the time based user activity data, the time based instruction data, and optionally, the time based merchandising information may be aggregated together such that the received information may be viewed in a timeline or a calendar view of various types.

The process provides 712 the aggregated time based data such that it may be viewed by a user on a client device executing a web application. In one embodiment, the process generates user interface elements displaying one of several views, including but not limited to an instructive view, a user activity data view and an aggregate time based user activity view. In another embodiment, the process provides 712 the aggregated data to an interface system 165 wherein the interface system 165 generates the user interface elements based on the aggregated data and the view requested by a user. The interface elements and views are discussed in greater detail with reference to FIGS. 8-10.

FIG. 8 illustrates a user interface displaying a time based instructive view, in accordance with an embodiment. The instructions may include, for example, times and dates associated with reading assignments, homework assignments, in-class assignments, exams, etc. As described above, the time based instruction data may be extracted from a variety of sources, including but not limited to a course syllabus, instructions provided by an instructor, a user's calendar, etc. In one embodiment, a syllabus 802 for a course includes information about reading materials and references, information about a lecturer and teaching assistants, an outline based on number of chapters, a schedule of test dates, due dates for assignments, classroom rules and grading policy. For example, if a course is 16 weeks in length, includes reading assignments for 8 chapters of a textbook, provides a test during weeks 4 and 10, assignments during weeks 1, 7 and 13, such information is provided in a time based instructive view interface 804. Continuing with the example syllabus provided above, the time based instructive view interface 804 provides a visual arrangement of weeks 1 though 16, with modules or interface elements showing assignment and exam due dates in rows associated with associated weeks. A third row of reading assignments may also be provided wherein the reading assignments also correspond with one or more weeks associated with the reading. As such, a user may view his or her course schedule in one view. A more or less detailed view may be generated for a user based on user inputs and preferences. Optionally, a user's progress through the assignments may also be measured and displayed in the time based instructive view interface 804, for example by displaying checkmarks or other icons next to chapters that the user has read and assignments the user has finished.

FIG. 9 illustrates a user interface displaying a time based user activity view, in accordance with an embodiment. As described in the specification, when a user opens an web application executing on a client device to view content provided by the education digital reading platform, the user's actions are transmitted to a server associated with the platform and a session is opened, wherein the user's activities are stored until the user closes the application or logs off. A user may have several sessions throughout a day. In one embodiment, a time based user interface displaying a number of sessions 902 a user initiated in a given day is provided. For example, if on Day 1 of a given week, a user initiates two sessions, the user interface displays two sessions 902a for the day in a given week. Similarly, eight sessions 902b are displayed for Day 4 and four sessions 902c are displayed for Day 7. Additionally, the time based user activity view may also include details about each session in a session log 904. For example, if a user reads particular content of a textbook, generates user content or shares content with other users or instructors, such activities may be detailed in a session log 904. In addition, the session log 904 also includes metadata associated with each activity, such as a time, performance, etc. It is noted that a week's worth of activities are displayed in FIG. 9, however, more or fewer dates or weeks may be displayed to the user based on user inputs and preferences. As such, a user may track his or her user activity level for a given course. In one embodiment, the time based user activity data displayed in FIG. 9 and instructive data displayed in FIG. 8 may be displayed within a same user interface, allowing a user to track his or her progress against activities recommended by an instructor.

FIG. 10 illustrates a user interface displaying an aggregated user activity view, in accordance with an embodiment. In one embodiment, the education digital reading platform receives user activity data from several users in a classroom. In such an instance, the user activity data of users may be aggregated and displayed to a user. For example, for a day within a given week, an interface element 1002 may be displayed providing the number of sessions generated by users enrolled in a classroom. Additionally, each session may include a detailed session log 1004 providing a number of userIDs that created the sessions, the type of activities conducted within each session, and content shared by the other users. As such, users may track their progress against their peers or classmates enrolled in a particular class. In addition, the time based aggregated user activity view may be provided to an instructor, such that the instruction may chart each user's progress and map the progress against performance metrics for each user. In one embodiment, each user's session activity data is only shared with others if the user's privacy settings permit or enable the sharing feature.

The illustrations in FIGS. 8-10 are merely examples of aggregated time based displays of user activities and instructive data on an education digital reading platform. Many others are also possible. For example, a timeline based view, which is not associated with dates may be provided to a user, etc.

### Additional Configuration Considerations

The present invention has been described in particular detail with respect to several possible embodiments. Those of skill in the art will appreciate that the invention may be practiced in other embodiments. The particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer and run by a computer processor. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

In addition, the present invention is not limited to any particular programming language. It is appreciated that a variety of programming languages may be used to implement the teachings of the present invention as described herein, and any references to specific languages, such as HTML5, are provided for enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

What is claimed is:

1. A method of electronic content management and delivery, the method comprising:
receiving time based user activity data comprising a user's actions associated with pages of content, the pages constructed from markup language page elements;
receiving time based instruction data related to the content and the user;
aggregating the time based user activity data and the time based instruction data based on time; and
generating at least one time based view of the aggregated data.

2. The method of claim 1, wherein the pages of content comprise at least one of content from a published textbook and a time based learning activity.

3. The method of claim 1, wherein the pages of content comprise a learning activity, the learning activity comprising at least one of a quiz, an interactive lesson, a video and a slideshow.

4. The method of claim 1, wherein the user's actions associated with pages of content comprise at least one of reading pages of content, writing notes, highlighting, copying at least a portion of a page, viewing a video, sharing user generated content, sharing at least a portion of a page, answering questions and posting questions.

5. The method of claim 1, wherein the time based user activity data further comprises a time associated with a start of the user activity and a time associated with an end of the user activity.

6. The method of claim 1, wherein the time based instruction data further comprises a date for completing a task, the task comprising performing a user action associated with pages of content.

7. The method of claim 1, wherein time based instruction data includes at least one of information provided by an instructor and a syllabus.

8. The method of claim 1, further comprising:
receiving time based merchandising information associated with at least one of the pages of content and a user's actions and including at least a date or time to display the merchandising information to the user; and
aggregating the time based merchandising information with the time based user activity data and the time based instruction data.

9. The method of claim 8, further comprising displaying time based merchandising information at a time coinciding with at least one of a time based user action.

10. The method of claim 1, further comprising providing the aggregated data to a user in markup language page elements used to construct a time based view for a user.

11. The method of claim 10, wherein the time based view comprises at least one of a timeline view, a calendar view, and a comparison view displaying a user's activity compared to other users' activities.

12. The method of claim 10, wherein the time based view comprises time based user activity data and time based instruction data of an education life cycle.

13. The method of claim 10, wherein the time based view comprises a comparison between at least two users' time based activity data.

14. A computer-readable storage medium storing executable computer program instructions for electronic content management and delivery, the computer program instructions comprising instructions for:
receiving time based user activity data comprising a user's actions associated with pages of content, the pages constructed from markup language page elements;
receiving time based instruction data related to the content and the user;
aggregating the time based user activity data and the time based instruction data based on time; and
generating at least one time based view of the aggregated data.

15. The computer-readable medium of claim 14, wherein the pages of content comprise at least one of content from a published textbook and a time based learning activity.

16. The computer-readable medium of claim 14, wherein the pages of content comprise a learning activity, the learning activity comprising at least one of a quiz, an interactive lesson, a video and a slideshow.

17. The computer-readable medium of claim 14, wherein the user's actions associated with pages of content comprise at least one of reading pages of content, writing notes, highlighting, copying at least a portion of a page, viewing a video, sharing user generated content, sharing at least a portion of a page, answering questions and posting questions.

18. The computer-readable medium of claim 14, wherein the time based user activity data further comprises a time associated with a start of the user activity and a time associated with an end of the user activity.

19. The computer-readable medium of claim 14, wherein the time based instruction data further comprises a date for completing a task, the task comprising performing a user action associated with pages of content.

20. The computer-readable medium of claim 14, wherein the time based instruction data further comprises a date for completing a task, the task comprising performing a user action associated with pages of content.

21. The computer-readable medium of claim 14, further comprising instructions for:
receiving time based merchandising information associated with at least one of the pages of content and a user's actions and including at least a date or time to display the merchandising information to the user; and
aggregating the time based merchandising information with the time based user activity data and the time based instruction data

22. The computer-readable medium of claim 14, further comprising instructions for displaying time based merchandising information at a time coinciding with at least one of a time based user action.

23. The computer-readable medium of claim 14, further comprising instructions for providing the aggregated data to a user in markup language page elements used to construct a time based view for a user.

24. The computer-readable medium of claim 23, wherein the time based view comprises at least one of a timeline view, a calendar view, and a comparison view displaying a user's activity compared to other users' activities.

25. The computer-readable medium of claim 23, wherein the time based view comprises time based user activity data and time based instruction data of an education life cycle.

26. The computer-readable medium of claim 23, wherein the time based view comprises a comparison between at least two users' time based activity data.
